(19) United States
(12) Patent Application Publication
(10) Pub. No.: US 2025/0028411 A1
(43) Pub. Date: Jan. 23, 2025

(54) Radar Antenna in a Capacitance Module

(71) Applicant: Cirque Corporation, Sandy, UT (US)

(72) Inventor: Brian Monson, Farmington, UT (US)

(73) Assignee: Cirque Corporation, Sandy, UT (US)

(21) Appl. No.: 18/223,719

(22) Filed: Jul. 19, 2023

(51) Int. Cl. G06F 3/044; G01S 7/03; G01S 13/62; G06F 3/041; G06F 3/0488

(52) U.S. Cl. CPC G06F 3/044; G01S 7/03; G01S 13/62; G06F 3/0416; G06F 3/0488

(57) ABSTRACT

A capacitance module may include a stack of layers; at least one capacitance electrode on a surface of a first layer of the stack of layers; a radar antenna incorporated into the stack of layers.

### FIELD OF THE DISCLOSURE

This disclosure relates generally to systems and methods for detecting objects in the sensing range of a radar antenna in a capacitance module. In particular, this disclosure relates to systems and methods for detecting the presence of users near an electronic device using a radar antenna in a capacitance module.

### BACKGROUND

A touch pad is often incorporated into laptops and other devices to provide a mechanism for giving inputs to the device. For example, a touch pad may be positioned adjacent to a keyboard in a laptop and include a surface that can be touched by the user. Touch pads may operate using capacitive sensing, a technology that senses the change of capacitance where a finger touches the pad. In some examples, moving a finger, stylus, or another type of object adjacent on the touch pad may cause a cursor to move on a display in communication with the touch pad.

An example of a touch pad is disclosed in U.S. Pat. No. 7,400,318 issued to George Gerpheide, et al. This reference discloses a touch pad and measurement circuitry for enabling input to a computer or other electronic device. The system includes an X electrode, a Y electrode, a common sensing electrode, and a “water” electrode, wherein these four separate electrodes can be implemented in various physical configurations to obtain the desired effects, wherein moisture and water droplets can be identified and compensated for so as not to interfere with the input of data, wherein noise rejection is achieved by using a time aperture filtering method, wherein an improved scanning technique focuses scanning around an identified input object, wherein an adaptive motion filter responds to the speed and acceleration of an object being tracked, and wherein the measurement circuitry has an increased dynamic range enabling the touch pad to operate with greater tolerances to manufacturing variances. This reference is herein incorporated by reference for all that it contains.

A radar system is often used to detect the movement, shape, location, and speed of an object in the sensing range of the radar system.

An example of a radar system is disclosed in U.S. Pat. No. 018/0329050 issued to Patrick M. Amihood, et al. This reference discloses techniques and apparatuses that enable power management using a low-power radar. The described techniques enable a radar system to reduce overall power consumption, thereby facilitating incorporation and utilization of the radar system within power-limited devices. In one aspect, the radar system can replace other power-hungry sensors and provide improved performance in the presence of different environmental conditions, such as low lighting, motion, or overlapping targets. In another aspect, the radar system can cause other components within the electronic device to switch to an off-state based on detected activity in an external environment. By actively switching the components between an on-state or the off-state, the radar system enables the computing device to respond to changes in the external environment without the use of an automatic shut-off timer or a physical touch or verbal command from a user. Each of these references are herein incorporated by reference for all that they disclose.

### SUMMARY

In one embodiment, a capacitance module may include a stack of layers; at least one capacitance electrode on a surface of a first layer of the stack of layers; a radar antenna incorporated into the stack of layers.

The capacitance module may be incorporated into a touch screen.

The capacitance module may be positioned next to a working surface of an electronic device, where the working surface includes a keyboard, and the capacitance module may be offset from the keyboard.

The capacitance module may include a controller in communication with the radar antenna; memory in communication with the controller; and programmed instructions stored in the memory and configured, when executed, to cause the controller to receive a radar signal with the radar antenna; and determine a characteristic of an object within a sensing range of the capacitance module based, at least in part, on the received radar signal.

The characteristic may be a movement pattern.

The characteristic may be a location of the object in relation to the capacitance module.

The programmed instructions may cause the controller, when executed, to compare a received feature of the received radar signal against a stored feature of a profile; and determine that the object may be a user of an electronic device based at least in part on the comparison.

The programmed instructions may cause the controller, when executed, to compare a received feature of the received radar signal against a stored feature of a profile; and determine that the object may be a user of an electronic device based, at least in part, on the comparison.

The programmed instructions may cause the controller, when executed, to change a power management setting of the electronic device in response to determining that the object moved out of the sensing range.

The characteristic may be a position of a lid of the electronic device.

The programmed instructions may cause the controller, when executed, to change a power setting of the electronic device in response to determining the position of the lid.

The programmed instructions may cause the controller, when executed, to change a power management setting of the electronic device in response to determining that the object moved out of the sensing range.

The characteristic may include that the object is a user of an electronic device and that the user moved out of the sensing range.

The characteristic may include that the object is a user of an electronic device and that the user moved into the sensing range.

The programmed instructions may cause the controller, when executed, to compare a received feature of the received radar signal against a stored feature of a profile; and determine that the object may be moving proximate a keyboard of the electronic device; and determine that the movement of the object may be a predetermined gesture.

The programmed instructions may cause the controller, when executed, to compare a received feature of the received radar signal against a stored feature of a profile; and determine that the object may be moving proximate a display of the electronic device; and determine that the movement of the object may be a predetermined gesture.

A module may include a stack of layers; a display component on a surface of a first layer of the stack of layers; a radar antenna incorporated into the stack of layers.

The display component may be a touch screen.

The capacitance module may include a controller in communication with the radar antenna; memory in communication with the controller; and programmed instructions stored in the memory and configured, when executed, to cause the controller to receive a radar signal with the radar antenna; and determine a characteristic of an object within a sensing range of the capacitance module based, at least in part, on the received radar signal.

A computer-program product, the computer-program product may include a non-transitory computer-readable medium storing instructions executable by a processor to receive, from a radar antenna, a signal; execute a response in response to the signal.

A computer-program product, the computer-program product may include a non-transitory computer-readable medium storing instructions executable by a processor to receive, from a radar antenna in a first portion of an electronic device, a signal; analyze the properties of the received signal; determine the position of a second portion of the electronic device based, at least in part, on the properties of the received signal; and execute a response in response to determining the position of the second portion of the electronic device.

A computer-program product, the computer-program product may include a non-transitory computer-readable medium storing instructions executable by a processor to receive, from a radar antenna in a laptop computer, a signal; analyze the properties of the received signal; determine the presence of a user in range of the radar antenna based, at least in part, on the properties of the received signal; and execute a response in response to determining the presence of the user in range of the radar antenna.

A computer-program product, the computer-program product may include a non-transitory computer-readable medium storing instructions executable by a processor to receive, from a radar antenna in a laptop computer, a signal; analyze the properties of the received signal; determine the absence of a user in range of the radar antenna based, at least in part, on the properties of the received signal; and execute a response in response to determining the presence of the user in range of the radar antenna.

A computer-program product, the computer-program product may include a non-transitory computer-readable medium storing instructions executable by a processor to receive, from a radar antenna in a laptop computer, a signal; analyze the properties of the received signal; determine that user may be performing a gesture in range of the radar antenna based, at least in part, on the properties of the received signal; and execute a response in response to determining that the user performed a gesture in range of the radar antenna.

A module may include a display component; a radar antenna positioned adjacent to a side of the display component.

A module may include a display component; a camera positioned adjacent to a side of the display component; and a radar antenna positioned adjacent to the camera.

A module may include a speaker diaphragm, a speaker cover positioned adjacent to the speaker diaphragm; and a radar antenna adjacent to the speaker diaphragm.

A module may include a first portion of a keyboard input device; a second portion of the keyboard input device; and a radar antenna positioned in between the two portions of the keyboard input device.

### BRIEF DESCRIPTION OF THE DRAWINGS

FIG. 1 depicts an example of an electronic device in accordance with the disclosure.

FIG. 2 depicts an example of a substrate with a first set of electrodes and a second set of electrodes in accordance with the disclosure.

FIG. 3 depicts an example of a touch pad in accordance with the disclosure.

FIG. 4 depicts an example of a touch screen in accordance with the disclosure.

FIG. 5 depicts an example of detecting a user in accordance with the disclosure.

FIG. 6 depicts an example of a capacitance module with a radar antenna in accordance with the disclosure.

FIG. 7 depicts an example of a radar device in accordance with the disclosure.

FIG. 8 depicts an example of an electronic device with a radar antenna in accordance with the disclosure.

FIG. 9 depicts an example of an electronic device with a radar antenna in accordance with the disclosure.

FIG. 10 depicts an example of detecting a gesture in accordance with the disclosure.

FIG. 11 depicts an example of detecting a gesture in accordance with the disclosure.

FIG. 12 depicts an example of detecting a lid closure in accordance with the disclosure.

FIG. 13 depicts an example of detecting a lid closure in accordance with the disclosure.

FIG. 14 depicts an example of detecting a user in accordance with the disclosure.

FIG. 15 depicts an example of detecting a user in accordance with the disclosure.

FIG. 16 depicts an example of a method of detecting lid closure in accordance with the disclosure.

FIG. 17 depicts an example of a method of detecting a user in accordance with the disclosure.

FIG. 18 depicts an example of a method of detecting a gesture in accordance with the disclosure.

FIG. 19 depicts an example of an electronic device with a radar antenna in accordance with the disclosure.

FIG. 20 depicts an example of an electronic device with a radar antenna in accordance with the disclosure.

FIG. 21A depicts an example of an electronic device with a radar antenna in accordance with the disclosure.

FIG. 21B depicts an example of an electronic device with a radar antenna in accordance with the disclosure.

FIG. 22 depicts an example of an electronic device with a radar antenna in accordance with the disclosure.

FIG. 23 depicts an example of a method of using a radar device in accordance with the disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability, or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” may generally refer to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, electrode, or portions thereof, and the term “Rx” generally refers to a sense line, electrode, or portions thereof.

For the purposes of this disclosure, the term “electronic device” may generally refer to devices that can be transported and include a battery and electronic components. Examples may include a laptop, a desktop, a mobile phone, an electronic tablet, a personal digital device, a watch, a gaming controller, a gaming wearable device, a wearable device, a measurement device, an automation device, a security device, a display, a computer mouse, a vehicle, an infotainment system, an audio system, a control panel, another type of device, an athletic tracking device, a tracking device, a card reader, a purchasing station, a kiosk, or combinations thereof.

It should be understood that use of the terms “capacitance module,” “touch pad” and “touch sensor” throughout this document may be used interchangeably with “capacitive touch sensor,” “capacitive sensor,” “capacitance sensor,” “capacitive touch and proximity sensor,” “proximity sensor,” “touch and proximity sensor,” “touch panel,” “trackpad,” “touch pad,” and “touch screen.” The capacitance module may be incorporated into an electronic device.

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

In some cases, the capacitance module is located within a housing. The capacitance module may be underneath the housing and capable of detecting objects outside of the housing. In examples, where the capacitance module can detect changes in capacitance through a housing, the housing is a capacitance reference surface. For example, the capacitance module may be disclosed within a cavity formed by a keyboard housing of a computer, such as a laptop or other type of computing device, and the sensor may be disposed underneath a surface of the keyboard housing. In such an example, the keyboard housing adjacent to the capacitance module is the capacitance reference surface. In some examples, an opening may be formed in the housing, and an overlay may be positioned within the opening. In this example, the overlay is the capacitance reference surface. In such an example, the capacitance module may be positioned adjacent to a backside of the overlay, and the capacitance module may sense the presence of the object through the thickness of the overlay. For the purposes of this disclosure, the term “reference surface” may generally refer to a surface through which a pressure sensor, a capacitance sensor, or another type of sensor is positioned to sense a pressure, a presence, a position, a touch, a proximity, a capacitance, a magnetic property, an electric property, another type of property, or another characteristic, or combinations thereof that indicates an input. For example, the reference surface may be a housing, an overlay, or another type of surface through which the input is sensed. In some examples, the reference surface has no moving parts. In some examples, the reference surface may be made of any appropriate type of material, including, but not limited to, plastics, glass, a dielectric material, a metal, another type of material, or combinations thereof.

For the purposes of this disclosure, the term “display” may generally refer to a display or screen that is not depicted in the same area as the capacitive reference surface. In some cases, the display is incorporated into a laptop where a keyboard is located between the display and the capacitive reference surface. In some examples where the capacitive reference surface is incorporated into a laptop, the capacitive reference surface may be part of a touch pad. Pressure sensors may be integrated into the stack making up the capacitance module. However, in some cases, the pressure sensors may be located at another part of the laptop, such as under the keyboard housing, but outside of the area used to sense touch inputs, on the side of the laptop, above the keyboard, to the side of the keyboard, at another location on the laptop, or at another location. In examples where these principles are integrated into a laptop, the display may be pivotally connected to the keyboard housing. The display may be a digital screen, a touch screen, another type of screen, or combinations thereof. In some cases, the display is located on the same device as the capacitive reference surface, and in other examples, the display is located on another device that is different from the device on which the capacitive reference surface is located. For example, the display may be projected onto a different surface, such as a wall or projector screen. In some examples, the reference surface may be located on an input or gaming controller, and the display is located on a wearable device, such as a virtual reality or augmented reality screen. In some cases, the reference surface and the display are located on the same surface, but on separate locations on that surface. In other examples, the reference surface and the display may be integrated into the same device, but on different surfaces. In some cases, the reference surface and the display may be oriented at different angular orientations with respect to each other.

For the purposes of this disclosure, the term “radar antenna” may generally refer to a component that may send and/or receive radar signals to determine the shape, location, movement, speed, another characteristic and/or a combination thereof of an object within its sensing range. In some examples, a radar antenna may send out a radar signal and then receive the same radar signal back after the radar signal is reflected by objects within the radar antenna's sensing range. In some examples, a radar antenna may be driven by a controller and/or other electronic components. In some examples, a radar antenna may be a part of a radar circuit that may include a controller, receiver, transmitter, duplexer, and/or another appropriate electronic component.

For the purposes of this disclosure, the term “sensing range” may generally refer to the effective range of a radar antenna and/or device, at which the antenna and/or device can detect an object by sending and receiving a radar signal. In some examples, a sensing range may be a three-dimensional range in specific directions away from a radar antenna. For example, a radar antenna in a capacitance module of a laptop computer may have a sensing range that has a length of three meters in every direction not obstructed by the housing, the capacitance module and/or other components of the laptop computer. A radar antenna and/or device may determine the location, shape, speed, movement, and/or another property of an object within its sensing range.

For the purposes of this disclosure, the term “received features” may generally refer to properties or features of a radar signal that is received by a radar antenna. Some examples of received features may include frequency of the signal, the time from when the signal was sent to when it was received, amplitude, harmonic content, any other property of a radar signal, or a combination thereof. Received features may be compared against stored features to determine if the received signal is detecting a known object and/or action of a known object.

For the purposes of this disclosure, the term “stored features” may generally refer to properties or features of a radar signal that is stored in memory. In some examples, stored features may be created by recording and analyzing received features of signals in known environments. For example, a stored feature may be created by recording radar signals as a human is moved in and out of the sensing range of a radar antenna. Features of the recorded signals may be stored in memory and compared to received signals later. In this way, a received signal may be analyzed for features related to a signal received when a human is in the sensing range of the radar antenna. If the features of the received signal match those of the stored signals, it may be determined that a similar environment is being detected by the received signal as was present when the stored signal was recorded.

For the purposes of this disclosure, the term “power management setting” may generally refer to a setting on a device that controls how and/or how much electrical power is used for operation. In some examples, a power management setting may control if no power is being used by a device, how much power is being used by a device, which components of a device are using power, or a combination thereof. A device with a power management setting may be a laptop computer, a desktop computer, a smartphone device, a smartwatch device, a mobile device, an electronic tablet, an electronic device, a mobile device, a navigation device, or another electronic device, or combinations thereof. In some examples, the power management setting of a laptop computer may control when the computer is in sleep mode, turned on, turned off, in another mode of operation, or combinations thereof.

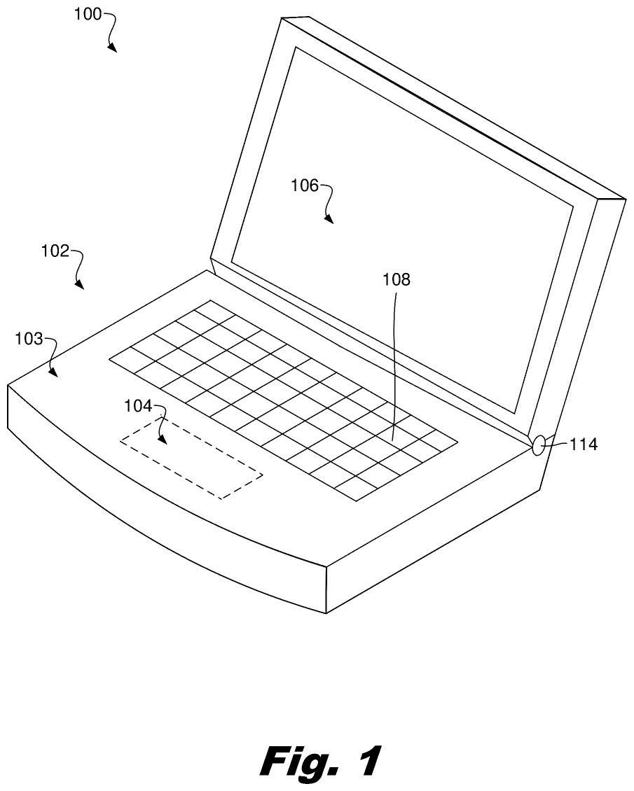

FIG. 1 depicts an example of an electronic device 100. In this example, the electronic device is a laptop. In the illustrated example, the electronic device 100 includes input components, such as a keyboard 102 and a capacitive module, such as a touch pad 104, that are incorporated into a housing 103. The electronic device 100 also includes a display 106. A program operated by the electronic device 100 may be depicted in the display 106 and controlled by a sequence of instructions that are provided by the user through the keyboard 102 and/or through the touch pad 104. An internal battery (not shown) may be used to power the operations of the electronic device 100.

The keyboard 102 includes an arrangement of keys 108 that can be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to give different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device's display and give a command through the touch pad 104 to select that object. For example, the user may provide instructions to select the object by tapping the surface of the touch pad 104 one or more times.

The touch pad 104 is a capacitance module that includes a stack of layers disposed underneath the keyboard housing, underneath an overlay that is fitted into an opening of the keyboard housing, or underneath another capacitive reference surface. In some examples, the capacitance module is located in an area of the keyboard's surface where the user's palms may rest while typing. The capacitance module may include a substrate, such as a printed circuit board or another type of substrate. One of the layers of the capacitance module may include a sensor layer that includes a first set of electrodes oriented in a first direction and a second layer of electrodes oriented in a second direction that is transverse the first direction. These electrodes may be spaced apart and/or electrically isolated from each other. The electrical isolation may be accomplished by deposited at least a portion of the electrodes on different sides of the same substrate or providing dedicated substrates for each set of electrodes. Capacitance may be measured at the overlapping intersections between the different sets of electrodes. However, as an object with a different dielectric value than the surrounding air (e.g., finger, stylus, etc.) approaches the intersections between the electrodes, the capacitance between the electrodes may change. This change in capacitance and the associated location of the object in relation to the capacitance module may be calculated to determine where the user is touching or hovering the object within the sensing range of the capacitance module. In some examples, the first set of electrodes and the second set of electrodes are equidistantly spaced with respect to each other. Thus, in these examples, the sensitivity of the capacitance module is the same in both directions. However, in other examples, the distance between the electrodes may be non-uniformly spaced to provide greater sensitivity for movements in certain directions.

In some cases, the display 106 is mechanically separate and movable with respect to the keyboard with a connection mechanism 114. In these examples, the display 106 and keyboard 102 may be connected and movable with respect to one another. The display 106 may be movable within a range of 0 degrees to 180 degrees or more with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 106 may be orientable with respect to the keyboard 102 at an angle between 35 to 135 degrees when in use by the user. However, in these examples, the display 106 may be positionable at any angle desired by the user.

In some examples, the display 106 may be a non-touch sensitive display. However, in other examples at least a portion of the display 106 is touch sensitive. In these examples, the touch sensitive display may also include a capacitance module that is located behind an outside surface of the display 106. As a user's finger or other object approaches the touch sensitive screen, the capacitance module may detect a change in capacitance as an input from the user.

While the example of FIG. 1 depicts an example of the electronic device being a laptop, the capacitance sensor and touch surface may be incorporated into any appropriate device. A non-exhaustive list of devices includes, but is not limited to, a desktop, a display, a screen, a kiosk, a computing device, an electronic tablet, a smart phone, a location sensor, a card reading sensor, another type of electronic device, another type of device, or combinations thereof.

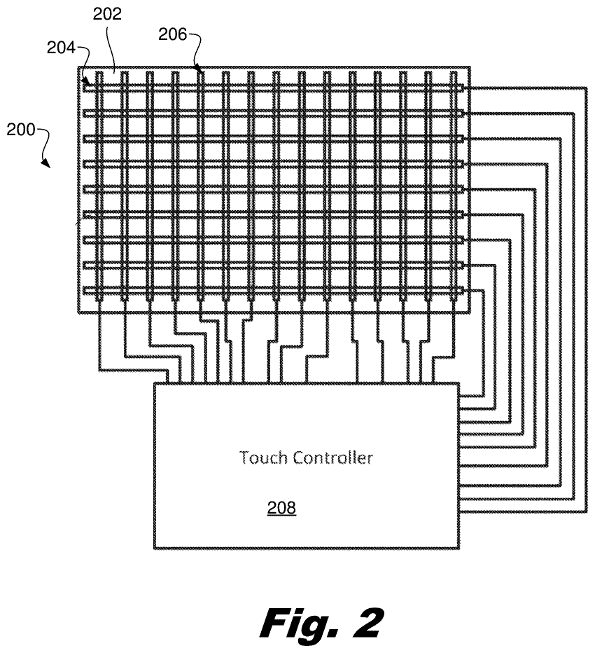

FIG. 2 depicts an example of a portion of a capacitance module 200. In this example, the capacitance module 200 may include a substrate 202, first set 204 of electrodes, and a second set 206 of electrodes. The first and second sets 204, 206 of electrodes may be oriented to be transverse to each other. Further, the first and second sets 204, 206 of electrodes may be electrically isolated from one another so that the electrodes do not short to each other. However, where electrodes from the first set 204 overlap with electrodes from the second set 206, capacitance can be measured. The capacitance module 200 may include one or more electrodes in the first set 204 or the second set 206. Such a substrate 202 and electrode sets may be incorporated into a touch screen, a touch pad, a location sensor, a gaming controller, a button, and/or detection circuitry.

In some examples, the capacitance module 200 is a mutual capacitance sensing device. In such an example, the substrate 202 has a set 204 of row electrodes and a set 206 of column electrodes that define the touch/proximity-sensitive area of the component. In some cases, the component is configured as a rectangular grid of an appropriate number of electrodes (e.g., 8-by-6, 16-by-12, 9-by-15, or the like).

As shown in FIG. 2, the capacitance module 208 includes a capacitance controller 208. The capacitance controller 208 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

In some cases, the capacitance controller 208 includes at least one multiplexing circuit to alternate which of the sets 204, 206 of electrodes are operating as drive electrodes and sense electrodes. The driving electrodes can be driven one at a time in sequence, or randomly, or drive multiple electrodes at the same time in encoded patterns. Other configurations are possible such as a self-capacitance mode where the electrodes are driven and sensed simultaneously.

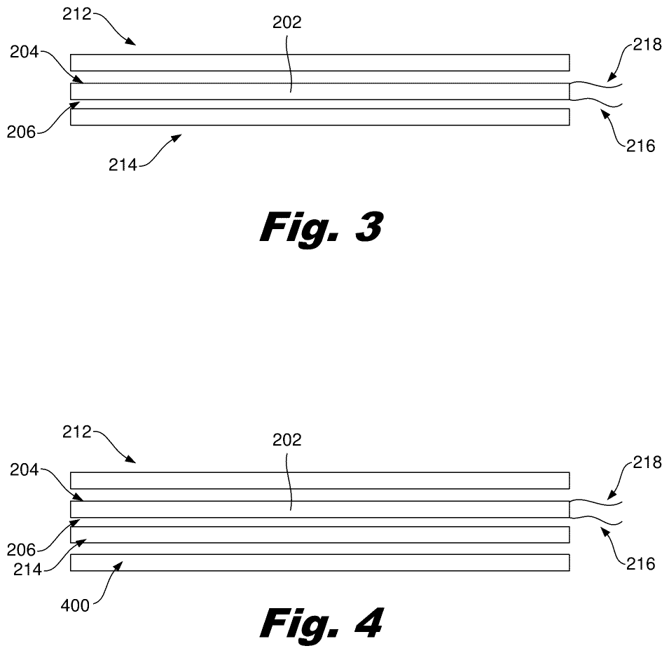

Electrodes may also be arranged in non-rectangular arrays, such as radial patterns, linear strings, or the like. A shield layer (see FIG. 3) may be provided beneath the electrodes to reduce noise or other interference. The shield may extend beyond the grid of electrodes. Other configurations are also possible.

In some cases, no fixed reference point is used for measurements. The touch controller 208 may generate signals that are sent directly to the first or second sets 204, 206 of electrodes in various patterns.

In some cases, the component does not depend upon an absolute capacitive measurement to determine the location of a finger (or stylus, pointer, or other object) on a surface of the capacitance module 200. The capacitance module 200 may measure an imbalance in electrical charge to the electrode functioning as a sense electrode which can, in some examples, be any of the electrodes designated in either set 204, 206 or, in other examples, with dedicated-sense electrodes. When no pointing object is on or near the capacitance module 200, the capacitance controller 208 may be in a balanced state, and there is no signal on the sense electrode. When a finger or other pointing object creates imbalance because of capacitive coupling, a change in capacitance may occur at the intersections between the sets of electrodes 204, 206 that make up the touch/proximity sensitive area. In some cases, the change in capacitance is measured. However, in an alternative example, the absolute capacitance value may be measured.

While this example has been described with the capacitance module 200 having the flexibility of the switching the sets 204, 206 of electrodes between sense and transmit electrodes, in other examples, each set of electrodes is dedicated to either a transmit function or a sense function.

FIG. 3 depicts an example of a substrate 202 with a first set 204 of electrodes and a second set 206 of electrodes deposited on the substrate 202 that is incorporated into a capacitance module. The first set 204 of electrodes and the second set 206 of electrodes may be spaced apart from each other and electrically isolated from each other. In the example depicted in FIG. 3, the first set 204 of electrodes is deposited on a first side of the substrate 202, and the second set 206 of electrodes is deposited on the second side of the substrate 202, where the second side is opposite the first side and spaced apart by the thickness of the substrate 202. The substrate may be made of an electrically insulating material thereby preventing the first and second sets 204, 206 of electrodes from shorting to each other. As depicted in FIG. 2, the first set 204 of electrodes and the second set 206 of electrodes may be oriented transversely to one another. Capacitance measurements may be taken where the intersections with the electrodes from the first set 204 and the second set 206 overlap. In some examples, a voltage may be applied to the transmit electrodes and the voltage of a sense electrode that overlaps with the transmit electrode may be measured. The voltage from the sense electrode may be used to determine the capacitance at the intersection where the sense electrode overlaps with the transmit electrode.

In the example of FIG. 3 depicting a cross section of a capacitance module, the substrate 202 may be located between a capacitance reference surface 212 and a shield 214. The capacitance reference surface 212 may be a covering that is placed over the first side of the substrate 202 and that is at least partially transparent to electric fields. As a user's finger or stylus approach the capacitance reference surface 212, the presence of the finger or the stylus may affect the electric fields on the substrate 202. With the presence of the finger or the stylus, the voltage measured from the sense electrode may be different than when the finger or the stylus are not present. As a result, the change in capacitance may be measured.

The shield 214 may be an electrically conductive layer that shields electric noise from the internal components of the electronic device. This shield may prevent influence on the electric fields on the substrate 202. In some cases, the shield is a solid piece of material that is electrically conductive. In other cases, the shield has a substrate and an electrically conductive material disposed on at least one substrate. In yet other examples, the shield is layer in the touch pad that performs a function and also shields the electrodes from electrically interfering noise. For example, in some examples, a pixel layer in display applications may form images that are visible through the capacitance reference surface, but also shields the electrodes from the electrical noise.

The voltage applied to the transmit electrodes may be carried through an electrical connection 216 from the touch controller 208 to the appropriate set of electrodes. The voltage applied to the sense electrode through the electric fields generated from the transmit electrode may be detected through the electrical connection 218 from the sense electrodes to the touch controller 208.

While the example of FIG. 3 has been depicted as having both sets of electrodes deposited on a substrate, one set of electrodes deposited on a first side and a second set of electrodes deposited on a second side; in other examples, each set of electrodes may be deposited on its own dedicated substrate.

Further, while the examples above describe a touch pad with a first set of electrodes and a second set of electrodes; in some examples, the capacitance module has a single set of electrodes. In such an example, the electrodes of the sensor layer may function as both the transmit and the receive electrodes. In some cases, a voltage may be applied to an electrode for a duration of time, which changes the capacitance surrounding the electrode. At the conclusion of the duration of time, the application of the voltage is discontinued. Then a voltage may be measured from the same electrode to determine the capacitance. If there is no object (e.g., finger, stylus, etc.) on or in the proximity of the capacitance reference surface, then the measured voltage off of the electrode after the voltage is discontinued may be at a value that is consistent with a baseline capacitance. However, if an object is touching or in proximity to the capacitance reference surface, then the measured voltage may indicate a change in capacitance from the baseline capacitance.

In some examples, the capacitance module has a first set of electrodes and a second set of electrodes and is communication with a controller that is set up to run both mutual capacitance measurements (e.g., using both the first set and the second set of electrodes to take a capacitance measurement) or self-capacitance measurements (e.g., using just one set of electrodes to take a capacitance measurement).

FIG. 4 depicts an example of a capacitance module incorporated into a touch screen. In this example, the substrate 202, sets of electrodes 204, 206, and electrical connections 216, 218 may be similar to the arrangement described in conjunction with FIG. 3. In the example of FIG. 4, the shield 214 is located between the substrate 202 and a display layer 400. The display layer 400 may be a layer of pixels or diodes that illuminate to generate an image. The display layer may be a liquid crystal display, a light emitting diode display, an organic light emitting diode display, an electroluminescent display, a quantum dot light emitting diode display, an incandescent filament display, a vacuum florescent display, a cathode gas display, another type of display, or combinations thereof. In this example, the shield 214, the substrate 202, and the capacitance reference surface 212 may all be at least partially optically transparent to allow the image depicted in the display layer to be visible to the user through the capacitance reference surface 212. Such a touch screen may be included in a monitor, a display assembly, a laptop, a mobile phone, a mobile device, an electronic tablet, a dashboard, a display panel, an infotainment device, another type of electronic device, or combinations thereof.

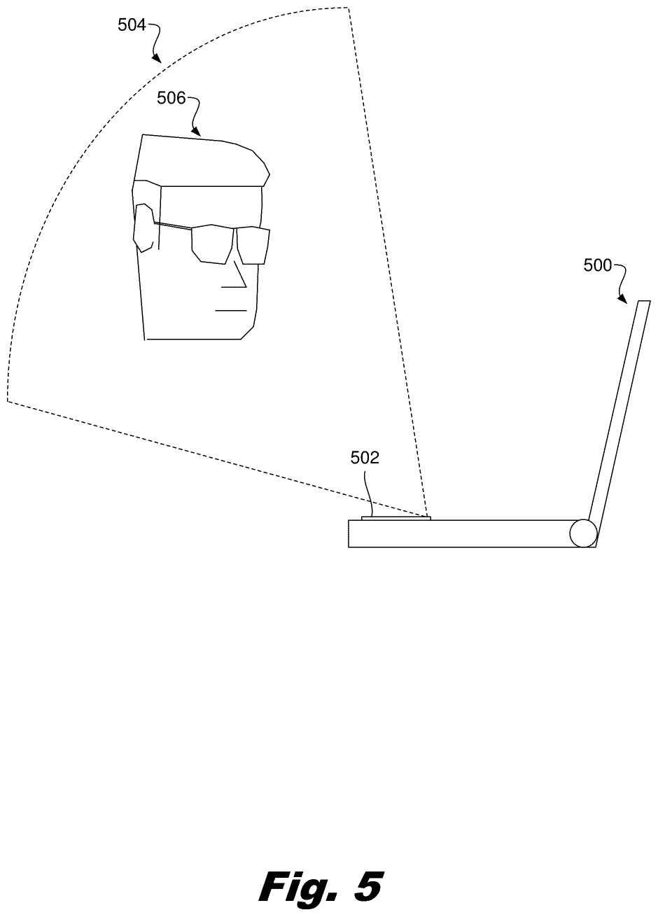

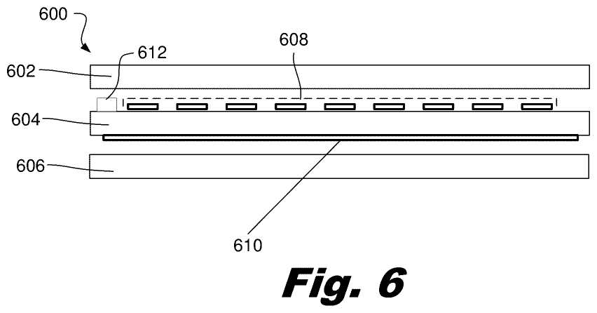

FIG. 5 depicts an example of an electronic device 500. In this example, the electronic device is a laptop computer. However, in another examples, the electronic device may be another type of device. A capacitance module 502 of the electronic device has a radar antenna that is obscured from view due to the internal position of the capacitance module in the electronic device 500. In some examples, the capacitance module 502 may have components used in a capacitance circuit used to detect movement of an object moving proximate a surface of the capacitance module. In some examples, the radar antenna of the capacitance module 502 may be part of a radar device used to detect movement of an object moving in the sensing range 504 of the radar antenna of the capacitance module 502. A user 506 within the sensing range 504 of the radar device may be detected by the antenna of the radar device in the capacitance module 502. In some examples, the user 506 may be moving into the sensing range 504 from outside of the sensing range. In some examples, the detection of the user 506 by the radar device may trigger a controller in communication with the radar device and/or other components of the electronic device to cause the electronic device 500 to come out of sleep mode, turn on, or change another power management setting. In some examples, the user 506 starting to be detected in the sensing range 504 may trigger a controller in communication with the radar device and/or other components of the electronic device to cause the electronic device 500 to respond with a predetermined response. In some examples, a user no longer being sensed within the sensing range 504 may trigger a controller in communication with the radar device and/or other components of the electronic device to cause the electronic device 500 to enter sleep mode, power down, or perform another function.

In some examples, the electronic device 500 may be in sleep mode before detecting the user 506 in the sensing range 504. In such an example, a controller in communication with the screen, keyboard, processor, portions of the capacitance module or any other component of the electronic device 500 may provide no power from the electronic device or less power than when the electronic device 500 is in use. The capacitance module 502 may be provided power by a controller in communication with the electronic device 500 when the electronic device is in sleep mode. In some examples, the radar antenna of the capacitance module 502 may be emitting and receiving radio waves to determine the location, shape, movement, another property and/or a combination thereof of objects in the sensing range 504 of the radar device. In some examples, when the user 506 enters the sensing range 504 of the radar device, a signal may be sent to a controller in communication with the radar device and/or the electronic device 500. In some examples, this signal may trigger a controller in communication with the radar device and/or other components of the electronic device to cause the electronic device to exit sleep mode, activate components of the electronic device, or perform another function.

In some examples, the sensing range 504 may be a range above the capacitance module 502 of the electronic device 500. In some examples, the sensing range 504 may be a range that surrounds the electronic device in some or all directions up to a certain distance. In some examples, the sensing range may extend up to three meters in one or more direction(s) away from the capacitance module 502. In some examples, the sensing range may be determined, at least in part, by the frequency and/or amplitude that the radar device in the capacitance module 502 is emitting and receiving a radio wave signal.

In some examples, an object in the sensing range 504 may be detected by the radar device. In some examples, the radar device may determine the direction and/or speed of a movement of an object in the sensing range 504. In some examples, the radar device may determine the characteristics of an object in the sensing range based, at least in part, on the shape of the object. In some examples, the radar device may determine that an object in the sensing range is a user. In some examples, the radar device may determine that an object is not a user. In some examples, when the radar device determines that an object is a user, the radar device may trigger a controller in communication with the radar device and/or other components of the electronic device to cause the electronic device 500 to perform a response. For example, when the radar device detects that a user has entered the sensing range 504, a controller in communication with the radar device and/or other components of the electronic device may cause the electronic device 500 to exit sleep mode, turn on, play a media source, trigger an audio response, turn up brightness on the display, turn on lights in the electronic device, or perform some other action.

In some examples, when the radar device determines that an object moving in the sensing range 504 is not a user, the radar device may trigger a controller in communication with the radar device and/or other components of the electronic device to cause the electronic device 500 to perform a response. For example, when the radar device determines that an object is moving but is not a user, a controller in communication with the laptop device 500 may trigger the electronic device to enter sleep mode, turn off, lock access to the electronic device, trigger a sound response, play a media source, or perform some other action. For example, if a user leaves a laptop on and out of sleep mode, the radar detecting movement that is not a user may indicate that an animal or a small child is approaching the electronic device. In such an example, the computer may lock or go to sleep to prevent changes to applications or documents on the electronic device.

In some examples, the radar device determining that a user is moving out of the sensing range 504 may trigger a controller in communication with the radar device and/or other components of the electronic device to cause the electronic device 500 to perform a response. For examples, when the radar device of the capacitance module 502 determines that a user is leaving the sensing range 504, a controller in communication with the electronic device may trigger the electronic device 500 to enter sleep mode, turn off, lock access to the electronic device, or perform some other action.

In some examples, the radar device connected to the radar antenna in the capacitance module 502 may determine that a user is performing a predetermined action. In some examples, the predetermined action may be an action with a user's hand. In some examples, the predetermined action may be an action with two hands. In some examples, the radar device determining that a user is performing a predetermined action may trigger a controller in communication with the radar device and/or other components of the electronic device to cause the electronic device to perform a response. The radar device may determine that a predetermined action has been input based, at least in part, on the speed, direction, shape, or another attribute of a movement of the user, and/or a combination thereof. In some examples, a controller in communication with the radar antenna in the capacitance module 502 and/or the electronic device 500 may trigger a predetermined response to be activated based, at least in part, on the predetermined action.

In some examples, the radar device may be able to distinguish a user from a user's pet or an inanimate object based on movement patterns of the user. In some examples, the movement patterns may include how the user approaches the electronic device, moves with respect to the electronic device, breathing movements, other types of movements, or combinations thereof.

For example, a user using the electronic device 500 may move their hand above the capacitance module 502 at a certain distance from the capacitance module from a first location above a first edge of the electronic device to a second location above a second edge of the electronic device 500. The radar device connected to the radar antenna in the capacitance module 502 may determine that the user has waved their hand over the electronic device 500. A controller in communication with the radar device and/or the electronic device 500 may trigger the content on the display of the electronic device to move, be swiped, or change applications.

In some examples, the radar antenna of the capacitance module 502 may be positioned within the capacitance module 502 so that it may clearly detect the range surrounding the capacitance module 502. In some examples, a controller in communication with the components of the capacitance module that are part of a capacitance sense circuit may be in communication with the radar antenna of the capacitance module 502.

In some examples, the capacitance circuit of the capacitance module 502 may be deactivated when the radar device is emitting and receiving radar signals. In some examples, a controller in communications with the radar device and/or the capacitance circuit of the capacitance module may cycle activating and deactivating the capacitance circuit and the radar device so that one is activated while the other is deactivated. In some examples, the touch circuit may be deactivated when the electronic device 500 is in sleep mode and the radar device may be activated when the electronic device is in sleep mode. In some cases, the capacitance sense circuit of the capacitance module 502 and the radar device may both detect a user input moving proximate to the capacitance module. In such an example, a controller or controllers in communication with the radar device and/or capacitance circuit may determine properties of the object, movement, input, or combination thereof, based, at least in part, on the measured signals of the radar device and/or the capacitance sense circuit. In some examples, the capacitance circuit is scheduled to activate a transmit electrode and/or measure with a sense electrode on a periodic basis with a predetermined intervening time between each action. During the intervening time between the capacitance circuit's the radar circuit may be scheduled to perform actions, such as sending and receiving signals.

In some examples, the radar device may detect the location of the display and/or lid of the laptop in relation to the capacitance module 502. In some examples, the display and/or lid of the electronic device 500 may fold, pivot, or otherwise move towards the capacitance module 502. In some examples, the radar device connected to the radar antenna of the capacitance module 502 may detect the movement of the display and/or lid of the electronic device 500 as it approaches the capacitance module 502. In some examples, the radar device may detect when the electronic device 500 is closed by determining the proximity of the display and/or lid of the electronic device to the capacitance module 502. When the radar device detects that the electronic device is closed, a controller in communication with the electronic device and/or the radar device may trigger the electronic device 500 to enter sleep mode, turn off, stop playing media, save the time position of a media source in memory for later recall, notify a secondary device (such as with an application on a smartwatch, smartphone, another computer or another electronic device), perform another action, or combinations thereof.

In some examples, the radar antenna of the capacitance module 502 may receive a radar signal. In some examples, the radar antenna may send and receive signals. In some examples, a second radar antenna may be positioned to interact with the radar antenna of the capacitance module. The second radar antenna may transmit a radar signal that may be received by the radar signal of the capacitance module 502.

In some examples, the radar antenna detecting an object in a certain location and/or with a certain shape may trigger a predetermined response. For example, if the radar antenna detects the palm of a user's hand in a certain location or moving in a particular way, the controller may send instructions that cause the electronic device to adjust a volume, change a brightness of a screen, send a message, adjust another parameter, trigger another action, or combinations thereof.

FIG. 6 depicts an example of a capacitance module 600. A first substrate 604 may be located between a reference surface 602 and a second substrate 606. The first substrate 604 has a first side with a first set 608 of electrodes and a second set 610 of electrodes. The second substrate 606 has a first side and a second side. In this example, the second substrate 606 is a shield. A radar antenna 612 is positioned adjacent to the first set of electrodes 608 on the first side of the first substrate 604. In some examples, the reference surface 602 is a non-metallic surface. In some examples, the radar antenna may send and receive radar signals through the reference surface 602. In some examples, the radar antenna is in communication with a controller that is also in communication with the sets 608, 610 of electrodes. In some examples, the set 608 of electrodes is a set of sense electrodes. In some examples, the set 610 of electrodes is a set of transmit electrodes. In some examples, the two sets 608, 610 of electrodes are part of a capacitance sense circuit. In some examples, the sets 608, 610 of electrodes are deactivated when the radar antenna 612 is sending and receiving radar signals. In some examples, the radar antenna is deactivated when the sets of electrodes are active.

In some examples, as an object moves proximate to the capacitance module 600, the sets 608, 610 of electrodes and the radar antenna 612 may detect the movement of the object. In some examples, the frequency at which the radar antenna is being driven at is higher than the frequency at which the sets 608, 610 of electrodes are being driven. In some examples, the radar antenna 612 may be driven at certain frequencies based, at least in part, on the frequency at which the sets of electrodes are being driven. In some examples, the first and/or second sets 608, 610 of electrodes are driven as may be determined, at least in part, by the frequency at which the radar antenna 612 is being driven.

For example, a radar signal may be transmitted and received at a frequency that shares few or no harmonic or base frequencies with the capacitance module 602. By driving the two components at these frequencies, the two components can reduce interference. In some examples, the capacitance reference surface 602 may be part of the working surface of an electronic device.

In some examples, a fourth substrate may be positioned beneath the shield 606 in the capacitance module. In such an example, a first side of the fourth layer may have components on it. In some examples, the fourth substrate may have a controller in communication with the first and/or second sets 608, 610 electrodes. The fourth substrate may have a controller in communication with the radar antenna 612. In some examples, one controller may be in communication with both the sets 608, 610 of electrodes and the radar antenna. In some examples, the fourth substrate of the capacitance module 600 may have other components of a radar device, such as a transmitter, a receiver, a duplexer, or any other suitable radar component. In some examples, radar components in communication with the radar antenna may be positioned elsewhere in the electronic device or on another substrate of the capacitance module 600.

In some examples, the sets 608, 610 of electrodes may be deactivated until the radar antenna 612 detects an object near the capacitance module. In some examples, the radar antenna 612 may be deactivated when the sets of electrodes sense an object moving proximity to the capacitance module 600. This may assist the capacitance module 600 in power conservation. A controller in communication with the capacitance module may activate the radar antenna for longer range detection and may activate the sets of electrodes for shorter range detection.

In some examples, a controller in communication with the capacitance module may tune the sensitivity of the sets 608, 610 of electrodes based, at least in part, on signals received by the radar antenna. For example, a user may place a finger on the capacitance reference surface 602. The radar may detect the location of the finger and a controller in communication with the sets 608, 610 of electrodes may calibrate the sensitivity of the electrodes based on the location of the finger as determined by the radar antenna 612. In some examples, a controller in communication with the radar antenna may calibrate the radar antenna based, at least in part, on signals received by the sets 608, 610 of electrodes.

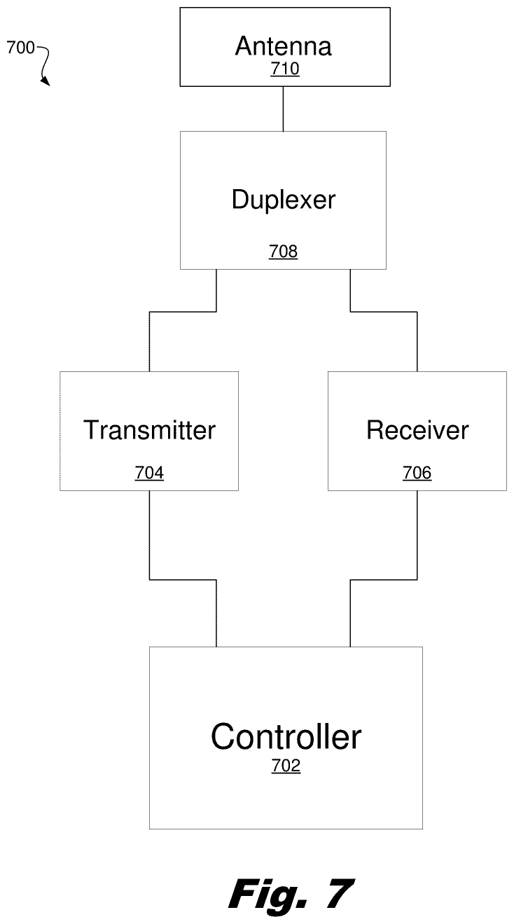

FIG. 7 depicts an example of a radar device 700. A controller 702 is in communication with a transmitter 704 and a receiver 706. A duplexer 708 connects the transmitter 704 and the receiver 706 to the antenna 710. In some examples, the transmitter 704 may apply a voltage to the duplexer 708 at a certain frequency. The duplexer 708 may apply the voltage to the antenna 710 to produce an emitted radio wave on the antenna 710. The antenna 710 may receive a radio wave and apply a voltage with the frequency of the radio wave to the duplexer 708. The duplexer may apply the voltage to the receiver 706. The controller 702 may determine the frequency at which the transmitter applies a voltage. The controller 702 may determine information about the physical range of the emitted signal of the antenna by analyzing the signal received by the receiver 706. The duplexer 708 may determine if the radar device 700 is transmitting a signal or receiving a signal by switching between applying the signal from the transmitter 704 to the antenna 710 and applying the signal received by the antenna to the receiver. In some examples, the duplexer may cycle between transmitting and receiving at a certain frequency based, at least in part, by the frequency of the transmitted signal. In some examples, the frequency and/or amplitude of the received signal may determine, at least in part, information about the range of the emitted signals from the antenna 710. In some examples, the time between transmitting a signal and receiving the signal back may determine, at least in part, the position, movement, identity, and/or a combination thereof, of an object in range of the signal emitted from the antenna.

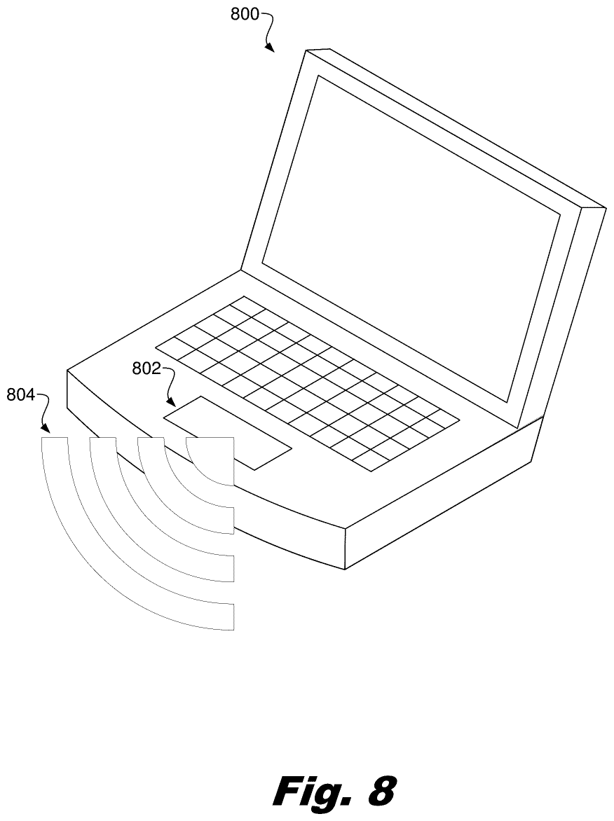

FIG. 8 depicts an example of an electronic device 700. In this example, the electronic device is a laptop computer. A capacitance module 802 has a radar antenna that is obscured from view due to the position of the capacitance module in the electronic device 800. A radar signal 804 is emitted from the radar antenna of the capacitance module 802. In some examples, the radar signal 804 is transmitted and received by the radar antenna of the capacitance module 802. By analyzing these transmitted and received signals, a controller in communication with the capacitance module may determine properties of objects within the radar antenna's sensing range.

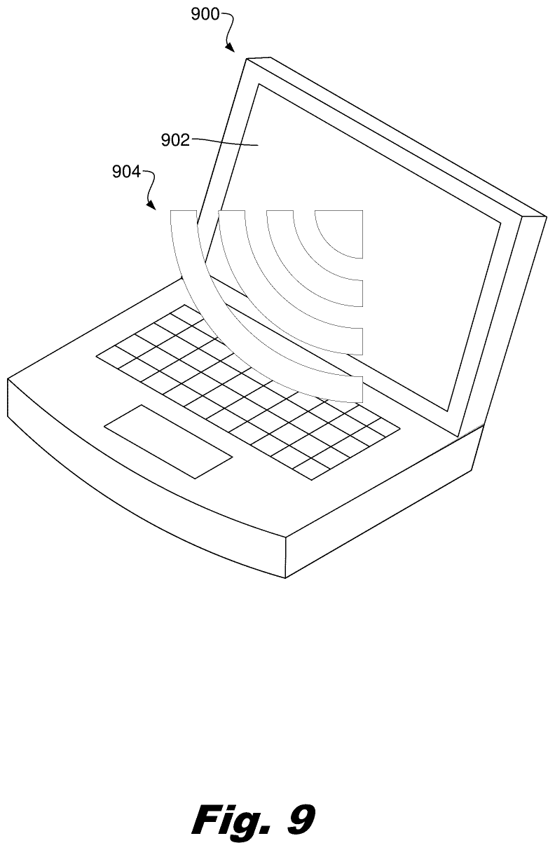

FIG. 9 depicts an example of an electronic device 900. A display 902 has a radar antenna that is obscured behind the screen of the display 902. A radar signal 904 is emitted from the radar antenna of the display 902. In some examples, the radar antenna of the display 902 may determine properties of objects in its sensing range based, at least in part, on transmitting and receiving the radar signal 904. In some examples, the display 902 is a touch screen and/or has a capacitance module. In some examples where the display includes a capacitance module, the radar antenna may be incorporated into the capacitance module and/or in communication with the capacitance module.

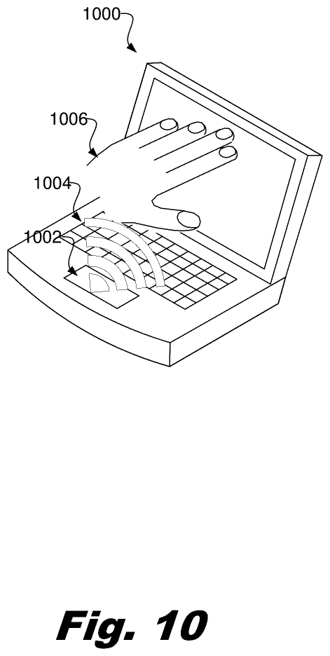

FIG. 10 depicts an example of an electronic device 1000. A capacitance module 1002 has a radar antenna (not shown). The radar antenna of the capacitance module 1002 is emitting a radar signal 1004. An object 1006 is positioned adjacent to the radar signal 1004. In this example, the object is a hand. In some examples, portions of the radar signal 1004 may bounce off the hand 1006 and be reflected back towards the radar device in the capacitance module 1002. In some examples, these reflected portions of the radar signal may be received by the radar antenna. In some examples, the radar device may determine attributes of the hand based, at least on part, on differences in received portions of the radar signal that were bounced back to the radar antenna. In some examples, the differences in the received portions may be the time at which the portions were emitted and received, the amplitude of the portions of the signal, the frequencies of the portions of the signal, any other feature of the portions of the signal, or a combination thereof. In some examples, a controller in communication with the radar antenna may determine the position, shape, movement, or a combination thereof, of the hand 1006.

In some examples, the radar antenna of the capacitance module 1002 may detect multiple signals or portions of signals as the hand moves above and/or near the capacitance module 1002. A controller in communication with the radar antenna may determine that the hand is moving. The controller in communication with the radar antenna may analyze multiple signals transmitted and received from the radar antenna to determine the path, speed, direction, angle, another property of the movement of the hand, or combinations thereof. In some examples, features of signals may be stored in memory and compared to received signals to determine that the user is performing a predetermined gesture with the hand 1006. In response to detecting this gesture, a response may be activated in the electronic device.

In some examples, a controller in communication with the radar antenna of the capacitance module 1002 may determine that the object 1006 is a hand, based, at least in part, on portions of the radar signal 1004 that were transmitted, reflected, and received by the radar antenna of the capacitance module. In some examples, the features of a signal or portions of a signal may be saved in memory, and received signals of the radar antenna may be compared to these features saved in memory. In some examples, if the features of a signal or portions of signals received by the radar antenna are similar to the features saved in memory, a controller in communication with the radar antenna of the capacitance module may determine that the object 1006 is a hand and/or gestures being performed by the hand. In some examples, the radar device may store features of signals or portions of signals of multiple objects or have access to a memory that stores such features. For example, these stored features may include features that help to identify human hands, humans, animals, fingers, the display, lid of the electronic device 900, other electronic devices, other parts or portions of the human body, household objects, objects in nature, any other appropriate object, or a combination thereof.

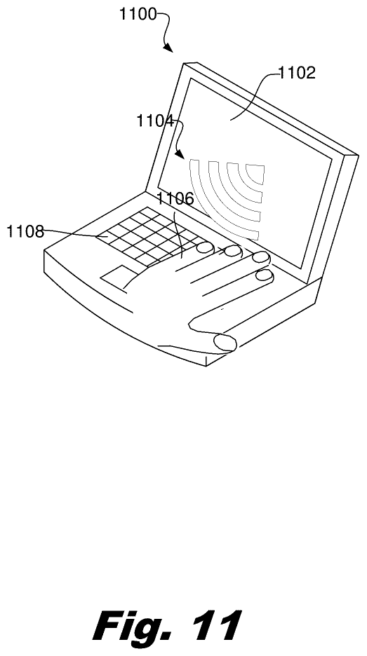

FIG. 11 depicts an example of an electronic device 1100. A display 1102 has a radar antenna that is not shown. The radar antenna may be a part of a radar device. The radar antenna of the display 1102 is emitting a radar signal 1104. A hand 1106 is moving above a keyboard 1108 of the electronic device. The radar antenna may detect gesture inputs proximate the display or another part of the electronic device.

In some examples, an action may be triggered when a gesture performed by the user is identified as being located within a trigger range. In some cases, the trigger range may be different than the sensing range. For example, the sensing range of the radar may be able to detect movement and/or objects that are located multiple meters away from the laptop. However, the trigger range may be a range that is smaller and where a user may more naturally intend to send instructions to the electronic device. In some examples, the trigger range may be defined by the height of the display, by the width of the display, and the depth of the keyboard surface. In other examples, the height of the trigger range may be smaller. In other examples, the height of the trigger range may extend beyond the height of the display. In other examples, the width of the trigger range may extend beyond the width of the display. In other examples, the depth of the trigger range may extend beyond the depth of the keyboard surface.

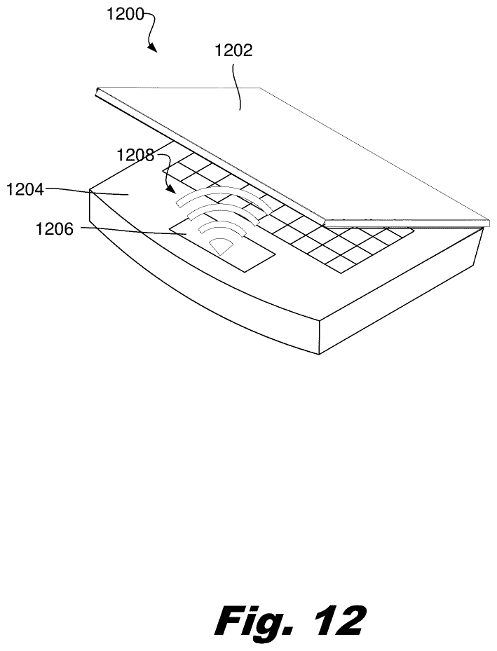

FIG. 12 depicts an example of an electronic device 1200. A capacitance module 1208 has a radar antenna that is not shown. The radar antenna is emitting a radar signal 1208. The capacitance module is part of a first portion 1202 of the electronic device. A second portion 1204 of the electronic device is moving towards the first portion. The radar antenna of the capacitance module 1208 may detect the position of the second portion 1204 of the electronic device. A controller in communication with the radar antenna may determine that the first portion of the electronic device is proximate the second portion of the electronic device and that the electronic device is closed. The electronic device may be turned off, put into sleep mode, or perform another function in response to the radar antenna detecting the position of the second portion of the electronic device.

In some examples, the capacitance module 1208 may detect the second portion of the electronic device capacitively and with radar at the same time. The second portion of the electronic device may have a display. The second portion of the electronic device may have a touchscreen. The capacitance module may detect the second portion of the electronic device by detecting electrical signals associated with the display and/or touchscreen of the second portion of the electronic device. In some examples, a controller in communication may determine that the laptop is closed using both capacitive and radar signals.

In some examples, the display and/or touchscreen of the second portion may have a radar antenna. In such an example, the radar antenna of the capacitance module 1208 may receive signals transmitted from the radar antenna of the display and/or touchscreen.

In some examples, the second position is when the lid is within closed range. In some examples, when the laptop lid is closed, the lid may be considered to be within the closed range. In other examples, the closed range may be up to one millimeter, two millimeters, a centimeter, two centimeters, an inch, an inch and a half, two inches, another distance, or combinations thereof.

In another example, the second position may be an intermediate position where the laptop is not considered to be fully closed or fully open. In some examples, the intermediate position may result an angle between a first portion of the electronic device and a second portion of the electronic device for a 45-degree angle, forming an angle between 40 and 50 degrees, forming an angle between 35 and 55 degrees, forming an angle between 5 and 85 degrees, another angle and/or range, or combinations thereof. In some examples, when the lid of determined to be in an intermediate position, the radar device may send instructions to execute an action. For example, moving the lid to an intermediate position may result in pausing a video, muting audio, pausing a program, muting a program, performing another task, or combinations thereof.

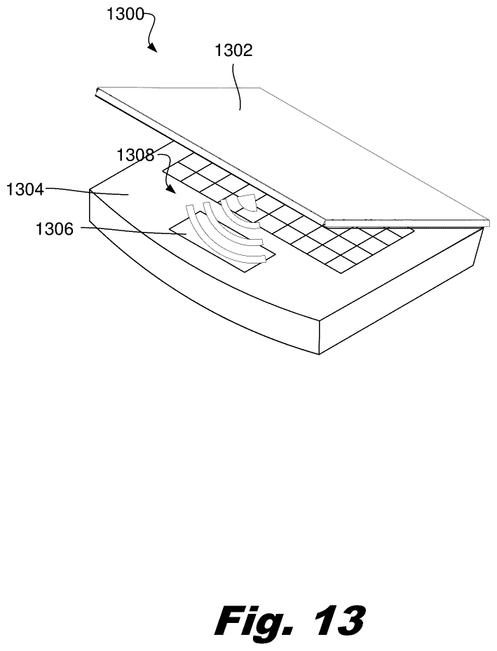

FIG. 13 depicts an example of an electronic device 1300 with a first portion 1302 and a second portion 1304. The first portion has a display (not shown) with a radar antenna. The radar antenna is emitting a radar signal 1308. A controller in communication with the radar antenna in the display of the second portion may determine that the laptop is closed based, at least in part, by the radar antenna detecting the position of the first portion of the electronic device.

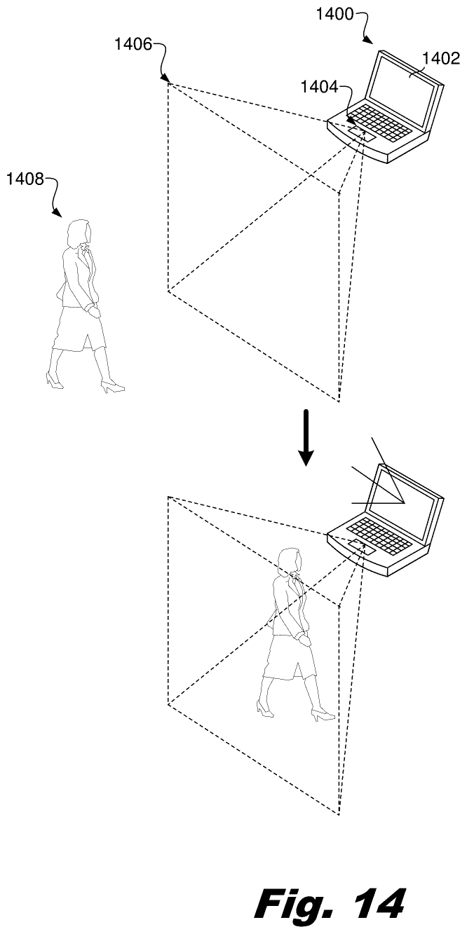

FIG. 14 depicts an example of an electronic device 1400. In this example, the electronic device has a first portion with a display 1402 and a second portion with a capacitance module 1404. The capacitance module has a radar antenna within the module that may be connected to a circuit that may send and/or receive radar signals. The radar antenna has a radar sensing range 1406. An object 1408 is moving into the radar sensing range 1406. In this illustrated example, the object 1408 is a user. Before the user enters the radar sensing range 1406, the display 1402 is powered off. As the user 1408 moves into the radar sensing range 1406, the radar antenna of the capacitance module 1404 may detect that the user is within the radar sensing range 1406. In response to detection, the electronic device 1400 may change power settings and/or the display 1402 may turn on.

While in this example the display 1402 is turned from off to on, in other examples other properties of the display may be changed. In some examples, the display is turned from a low brightness mode to a high brightness mode. In some examples, a program on the display may be activated by the electronic device 1400. In some examples, any detected movement within the radar sensing range 1406 may cause a response from the electronic device. In some examples, a controller in communication with the radar antenna of the capacitance module 1404 may determine whether the object 1408 is a user. In such an example, if the controller determines that the object is not a user, the electronic device may perform a different action than if the object were a user or take no action. In some examples, the electronic device may perform an action such as waking up from a sleep mode when the controller determines that the object 1408 is a user.

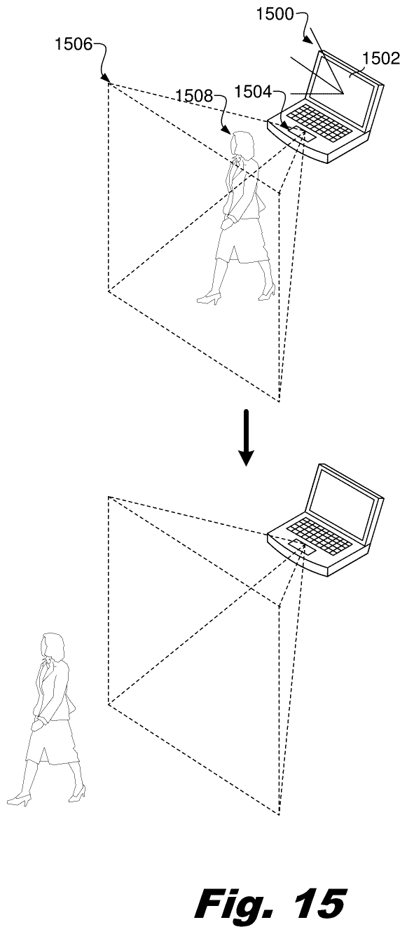

FIG. 15 depicts an example of an electronic device 1500. In this example, the computer has a first portion with a display 1502 and a second portion with a capacitance module 1504. The capacitance module has a radar antenna within the module that may be connected to a circuit that may send and/or receive radar signals. The radar antenna has a radar sensing range 1506. An object 1508 is moving out of the radar sensing range 1506. In this example, the object 1508 is a user. As the user 1508 moves out of the radar sensing range 1508, the display may change from powered on setting to powered off setting.

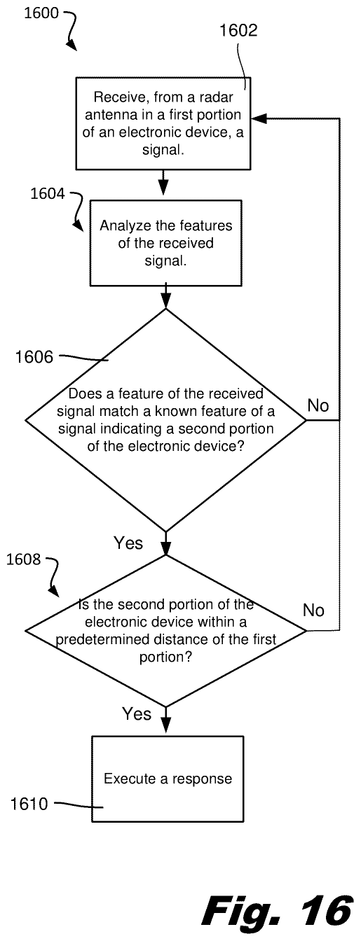

FIG. 16 depicts an example of a method 1600 of executing a response in response to receiving a signal on a radar antenna. This method 1600 may be performed based on the description of the devices, modules, and principles described in relation to FIGS. 1-15 and 19-22. In this example, the method 1600 includes receiving 1602, from a radar antenna in a first portion of an electronic device, a signal and analyzing 1604 the features of the received signal. The method 1600 also includes determining 1606 if the features of the received signal match known features of a signal indicating a second portion of the electronic device. If the features of the signal are known features of a signal indicating a second portion of the electronic device, the method 1600 also includes determining 1608 if the second portion of the electronic device is within a predetermined distance of the first portion of the electronic device. If the second portion of the electronic device is within a predetermined distance of the first portion of the electronic device, then the method 1600 also includes executing 1610 a predetermined response. If the second portion of the electronic device is not within a predetermined distance of the first portion of the electronic device, the method 1600 includes continuing to receive 1602 a signal from a radar antenna in a first portion of an electronic device. If the features of the received signal are not known features of a signal detecting the second portion of the electronic device, the method 1600 includes continuing to receive 1602 a signal from a radar antenna in a first portion of an electronic device.

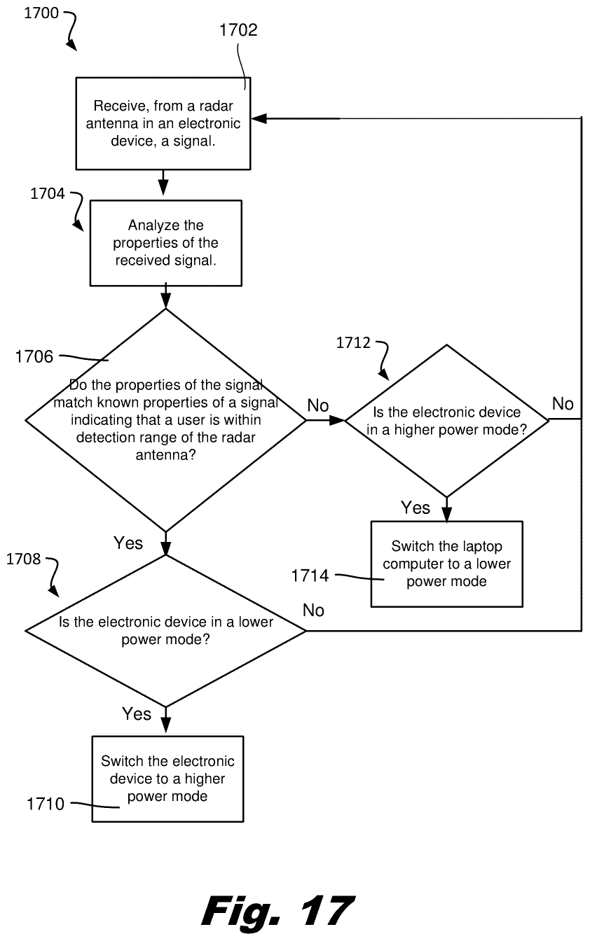

FIG. 17 depicts an example of a method 1700 of executing a response in response to receiving a signal on a radar antenna. This method 1700 may be performed based on the description of the devices, modules, and principles described in relation to FIGS. 1-15 and 19-22. In this example, the method 1700 includes receiving 1702, from a radar antenna in an electronic, a signal and analyzing 1704 the features of the received signal. The method 1700 also includes determining 1706 if the features of the received signal match known features of a signal indicating that a user is within sensing range of the radar antenna. If it is determined that a user is within sensing range of the radar antenna, the method 1700 includes determining 1708 if the electronic device is in a lower power mode. If the computer is in lower power mode and a user is in sensing range of the radar antenna, the method 1700 also includes switching 1710 the electronic device to a higher power mode. If the user is in sensing range and the electronic device is not in lower power mode, the method 1700 includes continuing 1702 to receive a signal from a radar antenna in the electronic device. If it is determined that a user is not within sensing range of the radar antenna, the method 1700 also includes determining 1712 if the electronic device is in a higher power mode. If the computer is in a higher power mode and a user is not within the sensing range of the radar antenna, the method 1700 also includes switching 1714 the electronic device to a lower power mode. If the computer is not in a higher power mode and a user is not detected within the sensing range of the radar antenna, the method 1700 includes continuing 1702 to receive a signal from a radar antenna in the electronic device.

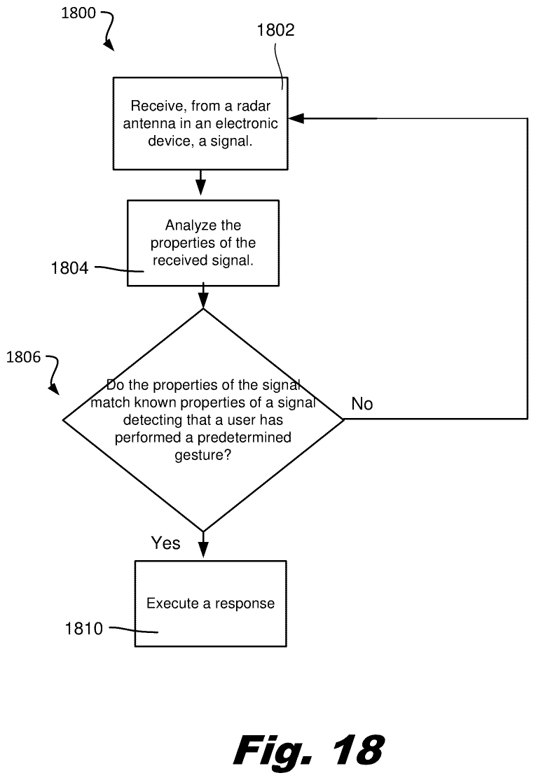

FIG. 18 depicts an example of a method 1800 of executing a response in response to receiving a signal on a radar antenna. This method 1800 may be performed based on the description of the devices, modules, and principles described in relation to FIGS. 1-15 and 19-22. In this example, the method 1800 includes receiving 1802, from a radar antenna in electronic device, a signal and analyzing 1804 the features of the received signal. The method 1800 also includes determining 1806 if the features of the received signal match known features of a signal detecting that a user has performed a predetermined gesture. If the features of the received signal match known features of a signal detecting that a user has performed a predetermined gesture, the method 1800 also includes executing 1810 a response. If the features of the received signal do not match known features of a signal detecting that a user has performed a predetermined gesture, the method includes continuing 1802 to receive a signal from a radar antenna.

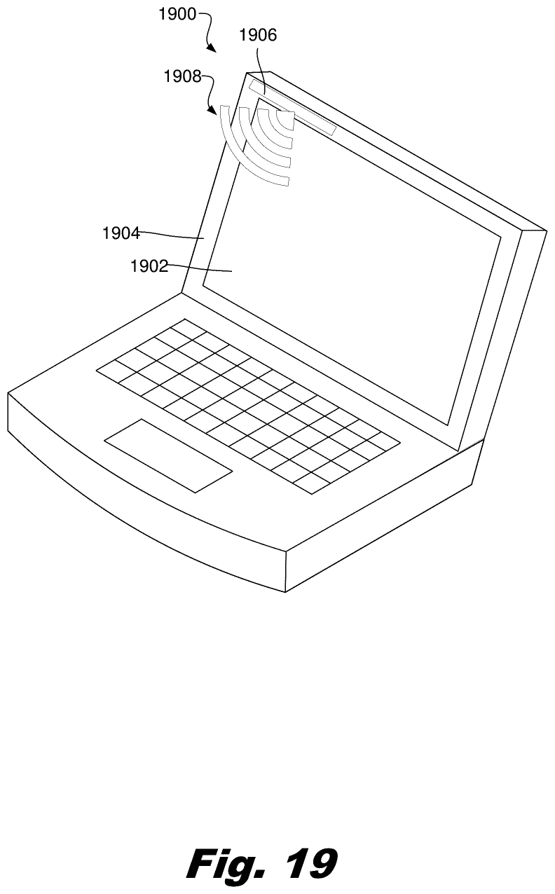

FIG. 19 depicts an example of an electronic device 1900. The electronic device has a display 1902 surrounded by a cover 1904. A cutout 1906 in the cover 1904 has a radar antenna that is obstructed from view by an overlay of the cutout. In some examples, the cover 1904 may be a metal cover. The radar antenna in the cutout 1906 may send and receive radar signals 1908 to determine properties of objects in range of the radar device. In this example, the radar device may or may not be in communication with a capacitance module.

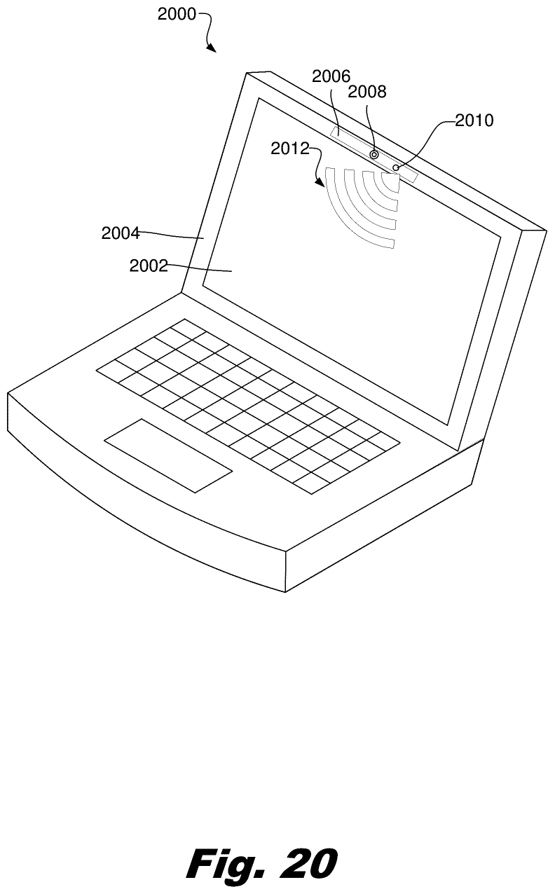

FIG. 20 depicts an example of an electronic device 2000. The electronic device has a display 2002 within a cover 2004. An area 2006 of the cover 2004 has a camera 2008 and a radar antenna 2010. The radar antenna 2010 may emit and receive a radar signal 2012. In this example, the radar device may or may not be in communication with a capacitance module. In some examples, the radar device may be incorporated into the camera device. In some instances, the camera device and the radar device may share at least one component. For example, at least one circuit of the camera device may be disposed on the same substrate as at least one circuit of the radar device. In other examples, the camera device and the radar device may share at least some of the same processing logic resources. The camera device and the radar device may be in communication with the same controller.

In some cases, the camera device may turn on, turn off, take a picture, send an image, process an image, refocus the camera, zoom in, zoom out, change brightness settings, change color settings, and an angle, switch to a video mode, switch to a still image mode, switch to another mode, change an aperture size, adjust a lens setting, change a timing setting, change a speed setting, or perform another operation based on input from the radar device. In other examples, the radar device may turn on, turn off, or perform another operation based on input from the camera device.

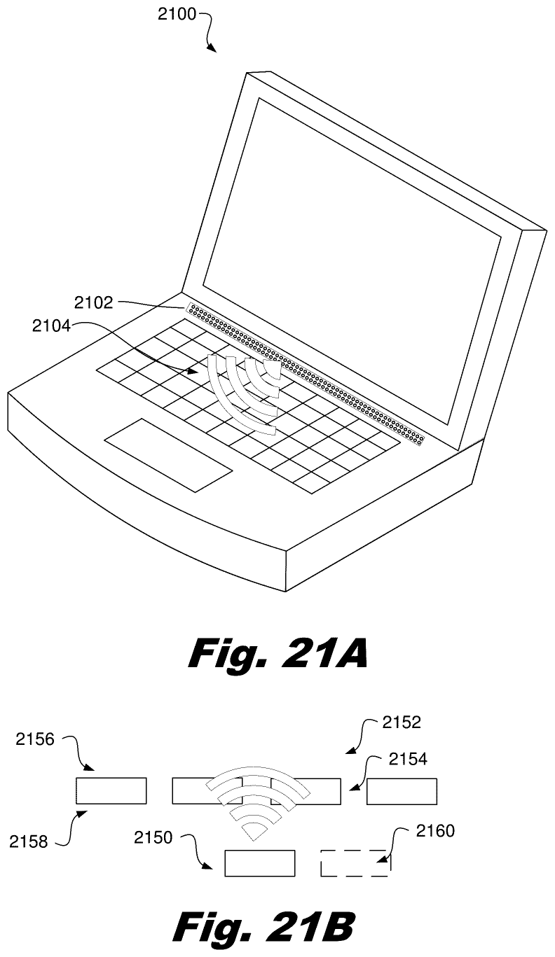

FIG. 21A depicts an example of an electronic device 2100. The electronic device has a speaker device 2102 with a radar antenna not shown due to the position of the face of the speaker device. The radar antenna may transmit and receive a radar signal 2104. In some cases, the cover of the electronic device may be made of a material that interferes with the transmission of a radar signal. In some such examples, the radar device may be positioned adjacent to a speaker opening and transmit and/or receive radar signals through the openings in a speaker grill associated with the speaker device.

FIG. 21B depicts an example of a radar device 2150 adjacent to a speaker grill 2152. At least one through opening 2154 that connects an outside surface 2156 of the electronic device housing to an inner surface 2158 of the electronic device housing is defined in the speaker grill 2152.

In this example, the radar device may or may not be in communication with a capacitance module. In some examples, the radar device may be incorporated into an audio device 2160, be positioned adjacent to an audio device 2160, or positioned elsewhere with respect to the audio device 2160. In some instances, the audio device and the radar device may share at least one component. For example, at least one circuit of the audio device may be disposed on the same substrate as at least one circuit of the radar device. In other examples, the audio device and the radar device may share at least some of the same processing logic resources. The audio device and the radar device may be in communication with the same controller. In some examples, the audio device includes a speaker.

In some cases, the audio device may turn on, turn off, adjust a volume setting, adjust a balance setting, adjust a frequency setting, adjust an amplitude setting, adjust a noise setting, or perform another operation based on input from the radar device.

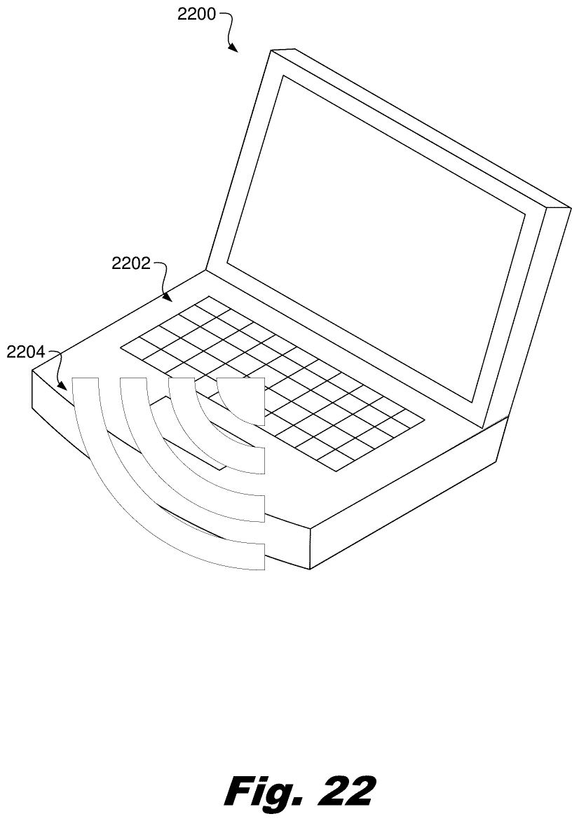

FIG. 22 depicts an example of an electronic device 2200. A keyboard 2202 is positioned in the electronic device so as to be operatable by a user. A radar antenna (not shown) is positioned within the keyboard 2202. The radar antenna may send and receive a radar signal 2204. In some examples, the radar device may be positioned adjacent to a through opening formed in the keyboard. The through opening may be formed between a gap between a movable key and cover. The radar device may be positioned to transmit and/or receive radar signals through the openings associated with the keyboard.

In this example, the radar device may or may not be in communication with a capacitance module. In some examples, the radar device may be incorporated into keyboard controller, circuitry, or other components of the keyboard. In some instances, the keyboard device and the radar device may share at least one component. For example, at least one circuit of the keyboard device may be disposed on the same substrate as at least one circuit of the radar device. In other examples, the keyboard device and the radar device may share at least some of the same processing logic resources. The keyboard device and the radar device may be in communication with the same controller. In some examples, keyboard device is a mechanical switch keyboard, a capacitance keyboard, another type of keyboard, or combinations thereof.

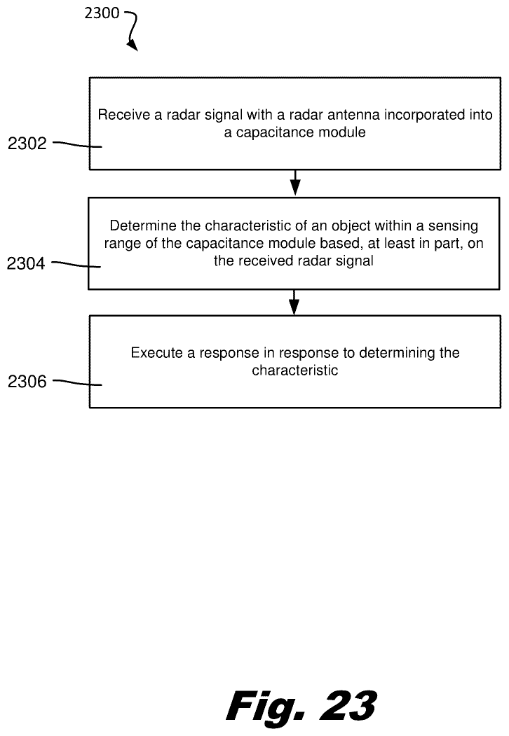

This method 2300 may be performed based on the description of the devices, modules, and FIG. 23 depicts an example of a method 2300 using a radar incorporated into a capacitance module and/or the principles described in relation to FIGS. 1-22. In this example, the method 2300 includes receiving 2302 a radar signal with the radar antenna incorporated into a capacitance module; determining 2304 a characteristic of an object within a sensing range of the capacitance module based, at least in part, on the received radar signal; executing 2306 a response in response to determining a characteristic.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A capacitance module, comprising:
a stack of layers;
at least one capacitance electrode on a surface of a first layer of the stack of layers; and
a radar antenna incorporated into the stack of layers.

2. The capacitance module of claim 1, wherein the capacitance module is incorporated into a touch screen.

3. The capacitance module of claim 1, wherein the capacitance module is positioned next to a working surface of an electronic device, wherein the working surface includes a keyboard, and the capacitance module is offset from the keyboard.

4. The capacitance module of claim 1, further comprising:
a controller in communication with the radar antenna;
memory in communication with the controller; and
programmed instructions stored in the memory and configured, when executed, to cause the controller to:
receive a radar signal with the radar antenna; and
determine a characteristic of an object within a sensing range of the capacitance module based, at least in part, on the received radar signal.

5. The capacitance module of claim 1, wherein the characteristic is a movement pattern.

6. The capacitance module of claim 1, wherein the characteristic is a location of the object in relation to the capacitance module.

7. The capacitance module of claim 1, wherein programmed instructions cause the controller, when executed, to:
compare a received feature of the received radar signal against a stored feature of a profile.

8. The capacitance module of claim 1, wherein programmed instructions cause the controller, when executed, to:
compare a received feature of the received radar signal against a stored feature of a profile; and
determine that the object is a user of an electronic device based, at least in part, on the comparison.

9. The capacitance module of claim 8, wherein programmed instructions cause the controller, when executed, to change a power management setting of the electronic device in response to determining that the object moved out of the sensing range.

10. The capacitance module of claim 1, wherein the characteristic is a position of a lid of the electronic device.

11. The capacitance module of claim 1, wherein programmed instructions cause the controller, when executed, to change a power setting of the electronic device in response to determining the position of the lid.

12. The capacitance module of claim 10, wherein programmed instructions cause the controller, when executed, to change a power management setting of the electronic device in response to determining that the object moved out of the sensing range.

13. The capacitance module of claim 1, wherein the characteristic includes that the object is a user of an electronic device and that the user moved out of the sensing range.

14. The capacitance module of claim 1, wherein the characteristic includes that the object is a user of an electronic device and that the user moved into the sensing range.

15. The capacitance module of claim 1, wherein programmed instructions cause the controller, when executed, to:
compare a received feature of the received radar signal against a stored feature of a profile;
determine that the object is moving proximate a keyboard of the electronic device; and
determine that the movement of the object is a predetermined gesture.

16. The capacitance module of claim 1, wherein programmed instructions cause the controller, when executed, to:
compare a received feature of the received radar signal against a stored feature of a profile;
determine that the object is moving proximate a display of the electronic device; and
determine that the movement of the object is a predetermined gesture.

17. A module, comprising:
a stack of layers;
a display component on a surface of a first layer of the stack of layers;
a radar antenna incorporated into the stack of layers.

18. The module of claim 16, wherein the display component is a touch screen.

19. The capacitance module of claim 16, further comprising:
a controller in communication with the radar antenna;
memory in communication with the controller; and
programmed instructions stored in the memory and configured, when executed, to cause the controller to:
receive a radar signal with the radar antenna; and
determine a characteristic of an object within a sensing range of the capacitance module based, at least in part, on the received radar signal.

20. A computer-program product, the computer-program product comprising a non-transitory computer-readable medium storing instructions executable by a processor to:
receive, from a radar antenna, a signal;
execute a response in response to the signal.
